(19) United States
(12) Patent Application Publication
(10) Pub. No.: US 2005/0061139 A1
(43) Pub. Date: Mar. 24, 2005

(54) Compilation album of one song performed by various artists

(76) Inventor: In Yong Chang, Syosset, NY (US)

Correspondence Address: IN YONG CHANG, 2 HARRIET DRIVE, SYOSSET, NY, 11791, US

(21) Appl. No.: 10/669,665

(22) Filed: Sep. 24, 2003

(51) Int. Cl. G10G 3/00

(52) U.S. Cl. 84/461

(57) ABSTRACT

A compilation album of one song performed by various artists. The album will allow for greater enjoyment of one particular song which is interpreted by popular singers, groups, and instrumentalists of today.

### BACKGROUND

The invention relates generally to the field of music entertainment and more specifically to album compilations.

Currently on the market, most albums consist of one singer or group performing various songs. This invention is a compilation of one song performed by various artists and methods.

### SUMMARY OF THE INVENTION

A primary object of the present invention is to provide listeners an opportunity to listen to an album of one particular song performed by a range of diverse singers, groups, musicians, and instrumentalists.

Listeners can enjoy interpretations by way of different methods, voices, instruments, and sounds, of society's greatest popular hits.

An additional object is to provide a means of comparison of different artists. Listeners can finally enjoy and compare how today's popular artists would perform the same song.

An additional object is to provide a listener an opportunity to listen to a favorite song on repeat but with the further option of hearing different variations of this song on a compilation album.

1. A compilation music album consisting of one song performed by various artists.
